(19) United States
(12) Patent Application Publication
(10) Pub. No.: US 2005/0004987 A1
(43) Pub. Date: Jan. 6, 2005

(54) Graphical user interface for uploading files

(75) Inventor: Aaron Bangor, Austin, TX (US)

Correspondence Address: TOLER & LARSON & ABEL L.L.P., 5000 PLAZA ON THE LAKE STE 265, AUSTIN, TX, 78746, US

(73) Assignee: SBC, Inc.

(21) Appl. No.: 10/614,718

(22) Filed: Jul. 3, 2003

(51) Int. Cl. G06F 15/16

(52) U.S. Cl. 709/206; 709/246

(57) ABSTRACT

A graphical user interface (GUI) comprises a first user-selectable button having associated text that includes a verbal of “attach”, and a second user-selectable button having associated text that includes an imperative for “attach”.

### FIELD OF THE DISCLOSURE

The present disclosure relates to graphical user interfaces.

### DESCRIPTION OF THE RELATED ART

Web-based and personal-computer-based email software allows users to attach files to email messages. A typical user interface for a Web-based email client has a text box into which a user can type a filename of the attachment. Adjacent to the text box is a button labeled “Browse” which provides an alternative to typing the file name into the text box. The “Browse” button triggers an operating system's file browsing feature to enable a user to select one file. In response to a file being selected, a full path name of the file is automatically populated in the text box. Thereafter, the user must click on a second button to upload the file to a Web server. After the file is uploaded, the user may follow the above procedure to add another file, or may click a third button to complete the upload process.

### BRIEF DESCRIPTION OF THE DRAWINGS

The present disclosure is pointed out with particularity in the appended claims. However, other features are described in the following detailed description in conjunction with the accompanying drawing in which:

FIG. 1 is a block diagram of an embodiment of a system for uploading one or more files;

FIG. 2 is a flow chart of an embodiment of a method of uploading one or more files; and

FIG. 3 is an illustration of an embodiment of a graphical user interface to receive user commands for uploading files.

### DETAILED DESCRIPTION OF THE DRAWINGS

User testing has shown that the aforementioned uploading process is overly complicated and error prone for many users. The text box induces many users to type an incomplete filename rather than use the “Browse” button. Further, the label “Browse” is not well understood by users. After a file has been selected, many users fail to select the second button to upload the file. Instead, they click the third button to complete the process. Additionally, some operating systems currently limit only one file to be uploaded at a time.

Embodiments of the present disclosure address the aforementioned issues. In an embodiment, the “Browse” button is given a different label, such as “Find File to Attach”. This new label more specifically indicates the function of the button and why a user should select the button. Further, the text box is removed so that users do not mistakenly enter an incomplete filename into it. Optionally, once a file has been selected in an operating system's file browser, the file is automatically uploaded to a Web server without having to click an “Add” button or another manual act. This makes uploading multiple files at a time easier for the users. Another option is to upload all files in the list box when an “Attach Files” button is clicked.

The resulting graphical user interface reduces a number of steps needed to upload local files to a Web site, eliminates confusing user interface objects, and more easily allows multiple local files to be selected and uploaded at once. Thus, the user experience is made simpler and less error prone.

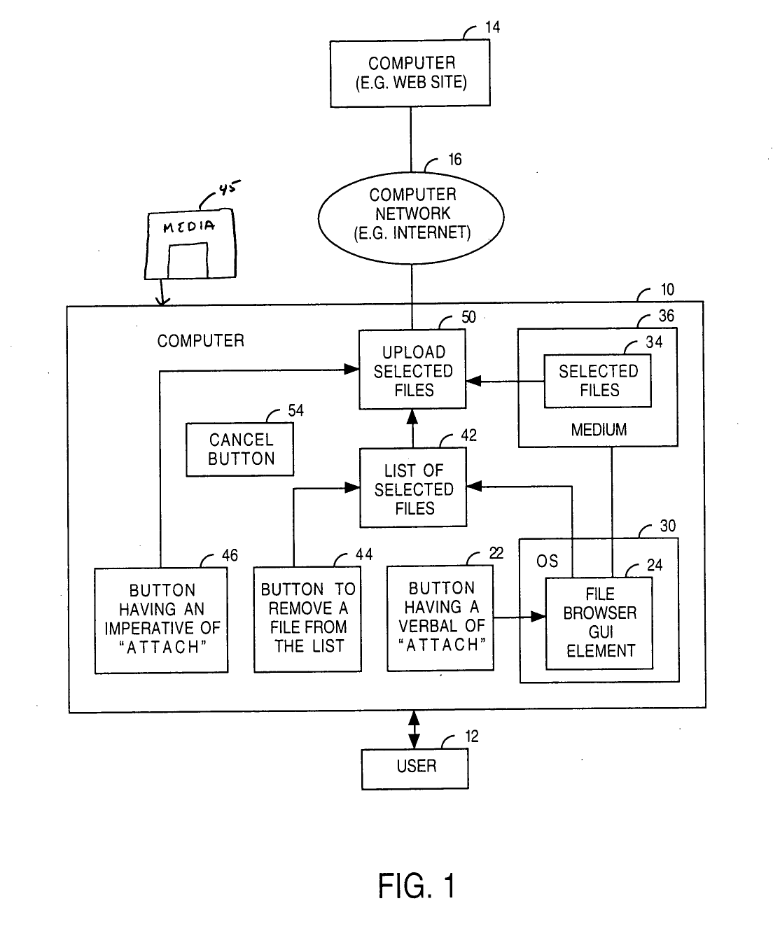

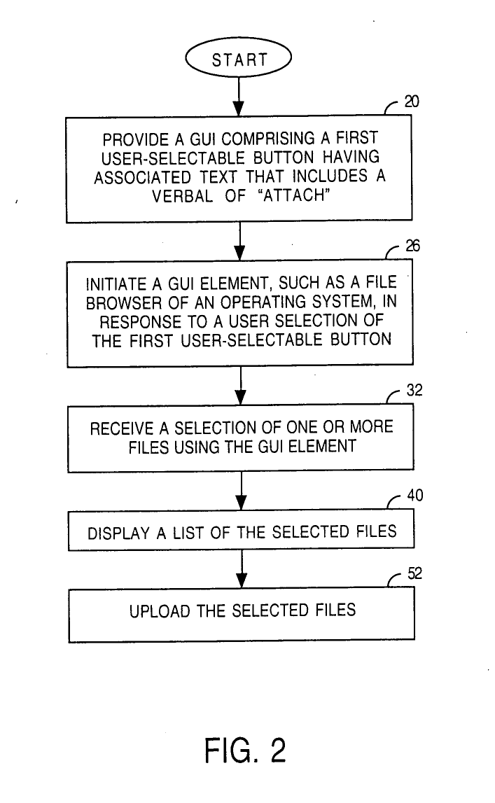

Embodiments of the present disclosure are described with reference to FIG. 1, which is a block diagram of an embodiment of a system for uploading one or more files, and FIG. 2, which is a flow chart of an embodiment of a method of uploading one or more files. The one or more files are to be uploaded from a computer 10 of a user 12 to another computer 14 via a computer network 16. Examples of the computer 10 include, but are not limited to, a desktop computer, a notebook computer, a tablet computer and a personal digital assistant. Examples of the computer 14 include, but are not limited to, a peer computer, a server computer, and an email server computer. In one embodiment, the computer 14 provides a Web site that provides email functionality and/or other messaging functionality. Examples of the computer network 16 include, but are not limited to, the Internet, an intranet, an extranet, a local area network, and a wide area network.

As indicated by block 20, the method comprises providing a graphical user interface (GUI) using the computer 10. The graphical user interface allows the user 12 to select which file(s) to upload, and to initiate the upload. The graphical user interface comprises a user-selectable button 22 having associated text that includes a verbal of the word “attach”. A verbal is defined as a group of words derived from a verb. The verbal may comprise either an infinitive of “attach” or a gerund of “attach”. In general, the infinitive includes the word “to”, and the gerund includes the word “for”.

The infinitive of “attach” may have either an adjectival-use form, a noun-use form, or an adverbial-use form. Regardless of which of the three forms is used, the infinitive may have either an active voice or a passive voice. TABLE I shows examples of text associated with the user-selectable button 22 using the various infinitives of “attach”. In one embodiment, the text includes an active voice, adjectival form of the infinitive of “attach”, such as “Find file to attach” or “Find files to attach”.

TABLE I

| Verbal | Form | Voice | Text associated with button |
|---|---|---|---|
| Infinitive | Adjectival | Active | Find file to attach |
| Infinitive | Adjectival | Passive | Find file to be attached |
| Infinitive | Noun | Active | Find file which to attach |
| Infinitive | Noun | Passive | Find file which is to be attached |
| Infinitive | Adverbial | Active | Find file you want to attach |
| Infinitive | Adverbial | Passive | Find file you want to be attached |
| Gerund | | | Find file for attaching |

As an alternative of the infinitive, the gerund of “attach” may be used. The gerund comprises “for attaching”. Thus, the text associated with the user-selectable button 22 may comprise “Find file for attaching” or “Find files for attaching”.

In response to receiving a selection of the user-selectable button 22 from the user 12, an act of initiating a GUI element 24 is performed (as indicated by block 26). In one embodiment, the GUI element 24 is a file browser of an operating system (OS) 30 of the computer 10. In general, the GUI element 24 may comprise a dialog box. The GUI element 24 allows the user 12 to find one or more files to attach to a message, such as an email message.

As indicated by block 32, the method comprises receiving a selection of one or more files 34 made by the user 12 using the GUI element 24. The one or more selected files 34 are present on a computer-readable medium 36 associated with the computer 10. Examples of the computer-readable medium 36 include, but are not limited to, a magnetic medium such as a hard disk or a floppy disk, an optical medium such as an optical disk (e.g. a CD or a DVD), or an electronic medium such as an internal electronic memory of the computer 10 or a removable memory card.

As indicated by block 40, the method comprises displaying a list 42 of the selected file(s) for view by the user 12. The GUI includes a user-selectable button 44 that allows the user 12 to selectively remove one or more of the selected file(s) from the list 42. The user 12 can select a file to be removed by pointing and clicking on its entry in the list, and then selecting the button 44. Alternatively, the user 12 can scroll the list 42 using scroll keys or a scroll wheel until a particular entry is highlighted, and then select the button 44 to remove the file associated with the highlighted entry from the list 42.

Optionally, the GUI further comprises a user-selectable button 46 having associated text that includes an imperative of “attach”. In an embodiment, the text consists of “Attach file” or “Attach files”. The user-selectable button 46 is to initiate a process 50 to upload the selected files 34 to attach same to the message.

As indicated by block 52, the method comprises uploading the selected files 34. The selected files 34 may be uploaded in response to the user 12 selecting the button 46. Alternatively, each selected file may be automatically uploaded once the user 12 has made its selection using the GUI element 24, such as the file browser of the OS 30. In either case, the selected files 34 are uploaded from the computer 10 to the computer 14 via the computer network 16. Optionally, the GUI comprises a cancel button 54 which, if selected by the user 12, aborts the act of uploading the selected files 34 in block 52.

FIG. 1 further illustrates a computer readable media 45. The computer readable media is used to store instructions capable of executing the methods described herein on a computer 10. Typically, the computer readable media will be a CD-ROM, a floppy, or a memory location. Memory locations can include memory sticks and mass storage devices. Mass storage devices may be connected directly to the computer 10, or may be network accessible.

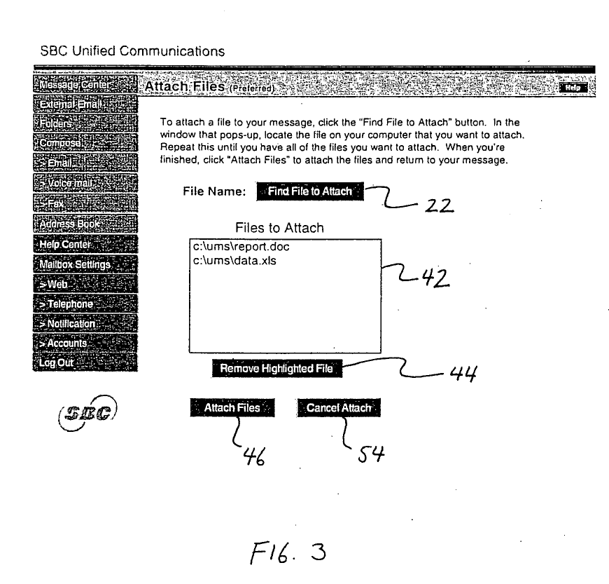

FIG. 3 is an illustration of an embodiment of the GUI to receive user commands for uploading files. The computer 14 in FIG. 1 provides the GUI, as part of a unified communications Web site, to the computer 10 via the computer network 16. The button 22 to initiate the file browser 24 of the OS 30 is labeled as “Find File to Attach”. The button 46 to initiate the upload process 50 is labeled as “Attach Files”. The button 44 to remove a file from the list 42 is labeled as “Remove Highlighted File”. The cancel button 54 is labeled as “Cancel Attach”. Each of the buttons has its associated text located within the button itself. Note that the GUI is absent a text box into which a user could type an incomplete filename.

Optionally, either in addition to or as an alternative to having the associated text within each of the buttons 22, 44, 46 and 54, the associated text may be provided in another form. For example, each associated text may be included in a markup language tag associated with its corresponding one of the buttons 22, 44, 46 and 54. The associated text may be included in a value of an attribute, such as an ALT=“text” attribute and/or a TITLE=“text” attribute, of the tag. Using the tags or alternative types of computer code, a mouse-over event for any of the buttons 22, 44, 46 and 54 can cause its associated text to be displayed by the computer 10. Further, if the computer 10 is equipped with screen reader software and/or hardware, the associated text in the tag or alternative type of program code can be audibly displayed (e.g. speech synthesized) to the user 12. This assists blind users in using the GUI to upload files. Those having ordinary skill will appreciate that markup languages such as hypertext markup language (HTML) and other computer languages can be used to provide the aforementioned tool-tip like functionality with or without using tags.

It will be apparent to those skilled in the art that the disclosure herein may be modified in numerous ways and may assume many embodiments other than the preferred forms specifically set out and described herein.

Accordingly, the above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description

1. A graphical user interface (GUI) comprising:
a first user-selectable button having associated text that includes a verbal of “attach”.

2. The GUI of claim 1 wherein the verbal comprises an infinitive of “attach”.

3. The GUI of claim 2 wherein the infinitive has an adjectival-use form.

4. The GUI of claim 3 wherein the infinitive has an active voice.

5. The GUI of claim 4 wherein the text comprises “find file to attach”.

6. The GUI of claim 3 wherein the infinitive has a passive voice.

7. The GUI of claim 6 wherein the text comprises “find file to be attached”.

8. The GUI of claim 2 wherein the infinitive has a noun-use form.

9. The GUI of claim 8 wherein the infinitive has an active voice.

10. The GUI of claim 9 wherein the text comprises “find file which to attach”.

11. The GUI of claim 8 wherein the infinitive has a passive voice.

12. The GUI of claim 11 wherein the text comprises “find file which is to be attached”.

13. The GUI of claim 2 wherein the infinitive has an adverbial-use form.

14. The GUI of claim 13 wherein the infinitive has an active voice.

15. The GUI of claim 14 wherein the text comprises “find file you want to attach”.

16. The GUI of claim 13 wherein the infinitive has a passive voice.

17. The GUI of claim 16 wherein the text comprises “find file you want to be attached”.

18. The GUI of claim 1 wherein the verbal comprises a gerund of “attach”.

19. The GUI of claim 18 wherein the text comprises “find file for attaching”.

20. The GUI of claim 1 wherein the text is within the first user-selectable button.

21. The GUI of claim 1 further comprising:
a second user-selectable button having associated text that includes an imperative for “attach”.

22. The GUI of claim 21 wherein the text associated with the second user-selectable button comprises “attach file”.

23. The GUI of claim 21 wherein the text associated with the second user-selectable button comprises “attach files”.

24. The GUI of claim 1 wherein the first user-selectable button is to initiate a GUI element to find at least one file to attach to a message.

25. The GUI of claim 24 wherein the GUI element comprises a dialog box.

26. The GUI of claim 1 wherein the first user-selectable button is to initiate a file browser of an operating system.

27. A graphical user interface (GUI) comprising:
a first user-selectable button having associated text therein that includes “Find File to Attach”, the first user-selectable button to initiate a file browser of an operating system; and
a second user-selectable button having associated text therein that includes “Attach Files”, the second user-selectable button to initiate attaching one or more files found using the file browser.

28. A method comprising:
providing a first user-selectable button having associated text that includes a verbal of “attach”;
in response to receiving a user selection of the first user-selectable button, initiating a graphical user interface (GUI) element to find at least one file to attach to a message;
receiving a selection of a file with the GUI element; and
uploading the file.

29. The method of claim 28 wherein the verbal comprises an infinitive of “attach”.

30. The method of claim 29 wherein the infinitive has an adjectival-use form.

31. The method of claim 30 wherein the infinitive has an active voice.

32. The method of claim 31 wherein the text comprises “find file to attach”.

33. The method of claim 30 wherein the infinitive has a passive voice.

34. The method of claim 33 wherein the text comprises “find file to be attached”.

35. The method of claim 29 wherein the infinitive has a noun-use form.

36. The method of claim 35 wherein the infinitive has an active voice.

37. The method of claim 36 wherein the text comprises “find file which to attach”.

38. The method of claim 35 wherein the infinitive has a passive voice.

39. The method of claim 38 wherein the text comprises “find file which is to be attached”.

40. The method of claim 29 wherein the infinitive has an adverbial-use form.

41. The method of claim 40 wherein the infinitive has an active voice.

42. The method of claim 41 wherein the text comprises “find file you want to attach”.

43. The method of claim 40 wherein the infinitive has a passive voice.

44. The method of claim 43 wherein the text comprises “find file you want to be attached”.

45. The method of claim 28 wherein the verbal comprises a gerund of “attach”.

46. The method of claim 45 wherein the text comprises “find file for attaching”.

47. The method of claim 28 wherein the text is within the first user-selectable button.

48. The method of claim 28 further comprising:
providing a second user-selectable button having associated text that includes an imperative for “attach”, wherein said uploading is performed in response to a user selection of the second user-selectable button.

49. The method of claim 48 wherein the text associated with the second user-selectable button comprises “attach file”.

50. The method of claim 48 wherein the text associated with the second user-selectable button comprises “attach files”.

51. The method of claim 28 wherein the GUI element comprises a dialog box.

52. The method of claim 28 wherein the GUI element comprises a file browser of an operating system.

53. The method of claim 28 wherein the text is included in a tag associated with the first user-selectable button.

54. The method of claim 28 further comprising displaying the text in response to a mouse-over event associated with the first user-selectable button.

55. The method of claim 28 further comprising audibly displaying the text.

56. A computer readable media comprising:
a plurality of instructions for
providing a first user-selectable button having associated text that includes a verbal of “attach”;
in response to receiving a user selection of the first user-selectable button, initiating a graphical user interface (GUI) element to find at least one file to attach to a message;
receiving a selection of a file with the GUI element; and
uploading the file.
